(19) United States
(12) Patent Application Publication
(10) Pub. No.: US 2023/0159365 A1
(43) Pub. Date: May 25, 2023

(54) SYSTEM FOR REDUCING HARDNESS OF WATER BODY AND METHOD FOR REDUCING HARDNESS OF WATER BODY

(71) Applicant: QINGDAO UNIVERSITY OF TECHNOLOGY, Qingdao (CN)

(72) Inventors: Bo JIANG, Qingdao (CN); Xuchen BA, Qingdao (CN); Xuesong WANG, Qingdao (CN); Jinghua CHEN, Qingdao (CN); Lihua QI, Qingdao (CN); Xiaobin GUO, Qingdao (CN); Ning SHI, Qingdao (CN); Yijie LIU, Qingdao (CN); Juan WANG, Qingdao (CN)

(21) Appl. No.: 17/548,579

(22) Filed: Dec. 12, 2021

(30) Foreign Application Priority Data
Nov. 23, 2021 (CN) 202111390229.7

(51) Int. Cl. C02F 9/00

(52) U.S. Cl. CPC C02F 9/00; C02F 1/444

(57) ABSTRACT

The invention relates to a system for reducing the hardness of a water body. According to the system, the acidic water body near a filter element anode is continuously extracted in the electrolytic process, the effect of acid-alkali separation can be achieved without internally disposing an ion exchange membrane, acid-alkali mixing generated by electrodes slows down, the alkaline atmosphere of a cathode chamber is kept, and a good environment is provided for generation of calcium carbonate seed crystals; and meanwhile, the acidic water body extracted near the anode of an electrochemical electrolysis unit can be used for regenerating ion exchange resin in an ion exchange column, so that resources are fully utilized.

### FIELD OF THE APPLICATION

The invention belongs to the technical field of water treatment, and particularly relates to a system for reducing the hardness of a water body and a method for reducing the hardness of the water body.

### BACKGROUND

Hardness is an important index for water quality evaluation. Physical health of people may be affected, and many disadvantages may be caused to industrial production if the hardness of a water body is too high.

At present, methods for reducing the hardness of the water body comprise a chemical precipitation method, a chemical scale inhibition method, a reverse osmosis method, an ion exchange method (IE), an electrochemical method, etc.

The water body needs to be further neutralized as chemical reagents added in the chemical precipitation method have strong alkalinity. In addition, a large amount of generated sludge still needs to be treated in the follow-up process.

In the chemical scale inhibition method, although crystal growth can be slowed down to prevent scaling by using a scale inhibitor, the content of hardness ions in the water body is not reduced, and meanwhile eutrophication of the water body may be caused due to the existence of the phosphorus-containing scale inhibitor in drained waste water.

In the reverse osmosis method, a reverse osmosis membrane is prone to scaling as the hardness ions tend to be deposited on the surface of the membrane. Not only softening efficiency is gradually reduced, but also energy consumption is increased.

The ion exchange method (IE) has the defects that resin used in the ion exchange method (IE) needs to be regenerated regularly, corrosive chemical substances may be consumed, secondary waste water with strong acidity or strong alkalinity is generated, and a large quantity of auxiliary facilities are needed for storage of the chemical substances and treatment of the waste water.

In a traditional electrochemical scale removing system, a large cathode surface area is needed for achieving high hardness removing efficiency. A built-in ion exchange membrane can effectively separate acid and alkali, and the requirement for cathode area can be reduced while the hardness removing efficiency is improved. However, a cathode and anode chamber separating system has the problems of contamination of the ion exchange membrane, frequent replacement of the membrane, etc. In addition, crystals can be separated out of a water phase only after microfiltering effluent of a cathode chamber of the cathode and anode chamber separating system, but microfiltration membrane assemblies widely used on the market are high in manufacturing cost, and secondary pollution is easily caused in the regeneration process. Taking an MBR hollow fiber membrane as an example, fouling easily happens only after operation for several hours, and usually a large quantity of chemical agents, such as hydrochloric acid and oxalic acid are used for offline cleaning. Secondary pollution is caused by using the agents, the salt content of the target water body may be increased, and the membrane assemblies are easily damaged or destroyed in the cleaning process. The magnesium hardness of reaction effluent is hardly further reduced due to the competitive relation of Mg²⁺ and HCO₃⁻ for OH⁻, and solving the problem is still difficult.

### BRIEF SUMMARY OF THE DISCLOSURE

A system for reducing the hardness of a water body, comprises: an electrochemical electrolysis unit configured to electrolyze the water body, wherein the electrochemical electrolysis unit comprises a cathode and a filter element anode, and the acidic water body near the filter element anode is continuously extracted in the electrolysis process of the electrochemical electrolysis unit.

Specifically, the filter element anode is a titanium filter element, a titanium suboxide filter element or a carbon filter element; the cathode is a porous net cylinder made of stainless steel or titanium; and furthermore, a distance between the cathode and the filter element anode is 1 cm-10 cm.

The effect of acid-alkali separation can be achieved without a proton exchange membrane by continuously extracting the acidic water body near the filter element anode, the hardness removing effect of the water body can be improved, and losses of devices can be reduced.

Specifically, the system for reducing the hardness of the water body, further comprises:

a crystalline microfiltration unit for crystallizing and filtering CaCO₃ in the water body electrolyzed by the electrochemical electrolysis unit;

an ion exchange column configured to perform ion exchange on the water body from the crystalline microfiltration unit to remove Ca²⁺ and Mg²⁺;

and

a first power source configured to supply power to the electrochemical electrolysis unit;

wherein the filter element anode is cylindrical and has a cavity inside and a porous structure on the wall, and the pore size is 0.2-10 micrometers; and the acidic water body near the filter element anode is continuously extracted from the top end of the filter element anode in the electrolysis process of the electrochemical electrolysis unit. The anode of the electrochemical electrolysis unit uses this structure, when the acidic water body is extracted from the top end, the acidic water body outside the anode may enter the cavity inside from the wall of the anode, the acidic water body is effectively collected, and the effect of acid-alkali separation is improved.

On the basis of the abovementioned scheme, the electrochemical electrolysis unit continuously injects the acidic water body extracted from the top end of the filter element anode into the cavity of the filter element anode from the bottom end of the filter element anode in the electrolysis process; and the flow of the extracted acidic water body is greater than that of the injected acidic water body.

As the flow of the extracted acidic water body is greater than that of the injected acidic water body, the redundant acidic water body may be generated, thus, the system for reducing the hardness of the water body also may be provided with an acid storage tank, and the acid storage tank is configured to store the acidic water body extracted from the filter element anode.

Along with use of the ion exchange column, ion exchange resin in the ion exchange column may be continuously consumed, and the redundant acidic water body may be used for cleaning and regenerating the ion exchange resin in the ion exchange column.

The crystalline microfiltration unit comprises a crystalline microfiltration unit outer shell, a cylindrical cathode disposed on the inner wall of the crystalline microfiltration unit outer shell and a conductive filter element disposed in the crystalline microfiltration unit; and furthermore, the crystalline microfiltration unit comprises a second power source configured to regenerate the crystalline microfiltration unit, a positive electrode of the second power source is connected with the conductive filter element, and a negative electrode of the power source is connected with the cylindrical cathode.

The ion exchange column is filled with strong acidic or weak acidic cation exchange resin; and furthermore, the cation exchange resin is cation exchange resin is D113 type resin, DOWEX MAC-3 resin, AMBERLITE IRC83 resin or AMBERLITE IRC84 resin.

The patent further provides a method for reducing the hardness of the water body, comprises a step of electrolyzing the water body by using the electrochemical electrolysis unit, specifically, continuously extracting the acidic water body generated near the anode of the electrochemical electrolysis unit in the electrolysis process.

The anode used in the patent is a cylindrical filter element anode having a cavity inside and a porous structure on the wall, and the pore size is 0.2-10 micrometers; and thus actually the acidic water body near the filter element anode is continuously extracted from the top end of the filter element anode in the electrolysis process of the electrochemical electrolysis unit.

With reference to the whole system, the method for reducing the hardness of the water body provided by the patent comprises following specific steps:

(1) introducing the water body into the electrochemical electrolysis unit, and switching on the first power source for electrolysis;

(2) enabling the electrolyzed water body to enter the crystalline microfiltration unit to be crystallized and filtered; and

(3) enabling the filtered water body to enter the ion exchange column for ion exchange.

In step (1), the electrochemical electrolysis unit continuously extracts the acidic water body near the filter element anode from the top end of the filter element anode in the electrolysis process.

In step (1), the electrochemical electrolysis unit continuously injects the acidic water body extracted from the top end of the filter element anode into the cavity of the filter element anode from the bottom end of the filter element anode in the electrolysis process; and the flow of the extracted acidic water body is greater than that of the injected acidic water body.

In step (3), when the hardness of the water body flowing out of the ion exchange column reaches 100 mg/L, the acidic water body, extracted from the top end of the filter element anode, in the cavity of the filter element anode is used for cleaning and regenerating.

The invention has advantages and positive effects:

according to the method for extracting the acid liquid near the filter element anode through the electrochemical electrolysis unit in the invention, the effect of acid-alkali separation can be achieved without internally disposing an ion exchange membrane, acid-alkali mixing generated by electrodes slows down, the alkaline atmosphere of a cathode chamber is kept, and a good environment is provided for generation of calcium carbonate seed crystals; and meanwhile, the acidic water body extracted near the anode of the electrochemical electrolysis unit can be used for regenerating the ion exchange resin in the ion exchange column, so that resources are fully utilized.

Retention time needed for the sedimentation reaction of the calcium carbonate crystals is shortened through filtering of the conductive filter element, a facility, namely a large settling pond is not needed, and the investment of capital expenditure is reduced. Calcium carbonate filter cakes are formed on the surface of the filter element in the filtering process, so that the filtering effect is further enhanced. Meanwhile, the titanium filter element, the or the carbon filter element is used as the anode, rapid regeneration can be achieved under a power-on condition, and secondary pollution caused by waste water generated by acid washing and potential risks such as adding, storage and transportation of agents are avoided. The ion exchange column can further reduce Mg²⁺ hardly removed in the crystallization unit and keep effluent within a neutral range.

### BRIEF DESCRIPTION OF THE DRAWINGS

Those ordinarily skilled in the art can clearly know the advantages and beneficial effects of the invention by reading detailed description of specific implementations below. The accompanying drawings are illustrative, and are not supposed to limit the invention. In the drawings:

FIG. 1 is a structural schematic diagram of a system of the patent;

FIG. 2 is a structural schematic diagram of an electrochemical electrolysis unit in a system of the patent;

FIG. 3 is a schematic diagram of a water body flowing direction when acidic liquid is extracted in a system of the patent;

FIG. 4 is a structural schematic diagram of a crystalline microfiltration unit in a system of the invention;

FIG. 5 is an effect of reducing the hardness of a water body by using a system of the invention in an application example; and

FIG. 6 is impact of an effect of current density for reducing the hardness of a water body in an application example.

### DETAILED DESCRIPTION

Exemplary embodiments of the invention are described in further detail with reference to the accompanying drawings below. Although the exemplary embodiments of the invention are shown in the accompanying drawings, it shall be understood that the invention can be achieved in various forms without being limited by the embodiments illustrated here. On the contrary, the embodiments are provided to better understand the invention and completely transmit the scope of the invention to those skilled in the art.

### Embodiment 1

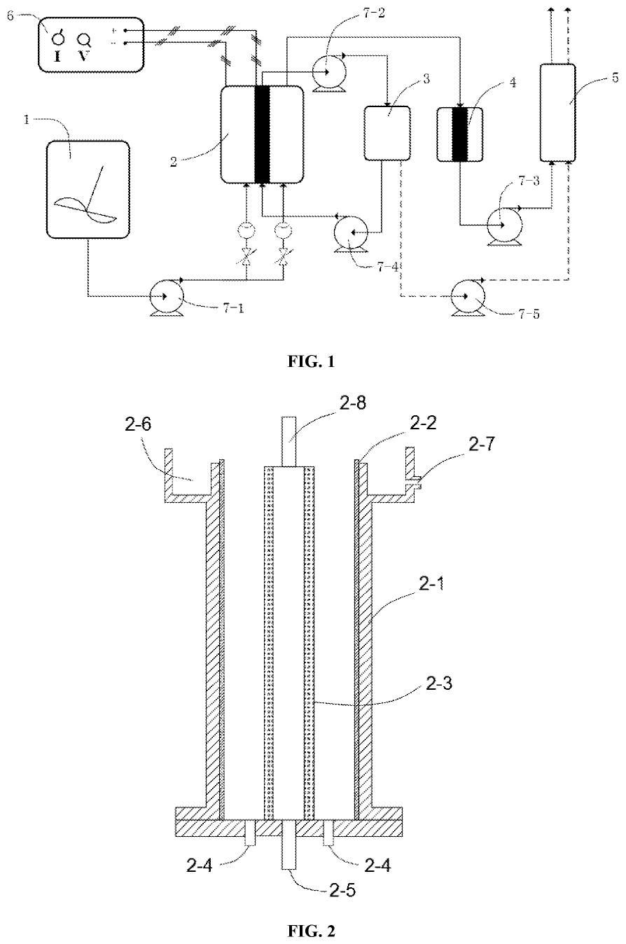

As shown in FIG. 1, a system for reducing the hardness of a water body through an electrochemical method comprises: an electrochemical electrolysis unit 2 for electrolyzing the water body, the electrochemical electrolysis unit 2 comprises a cathode 2-2 and a filter element anode 2-3, the acidic water body near the filter element anode 2-3 is continuously extracted in the electrolysis process of the electrochemical electrolysis unit 2, specifically, a first power source 6 supplies power to the electrolysis process, and current density of electrolysis is 1 mA/cm²-50 mA/cm².

During electrolysis, the following reaction can happen near the filter element anode 2-3:

2H₂O−4e⁻→O₂⬆+4H⁺

The following reaction can happen near the cathode:

2H₂O−2e⁻→H₂⬆+2OH⁻

O₂+2H₂O+4e⁻→4OH⁻

It follows that when the water body is electrolyzed, acid-alkali mixing is generated between the anode and the cathode, and in order to solve the problem, the system in the implementation adopts the following technical means: the acidic water body (such as extracting the acidic water body through a pump) near the filter element anode 2-3 is continuously extracted in the electrolysis process of the electrochemical electrolysis unit 2.

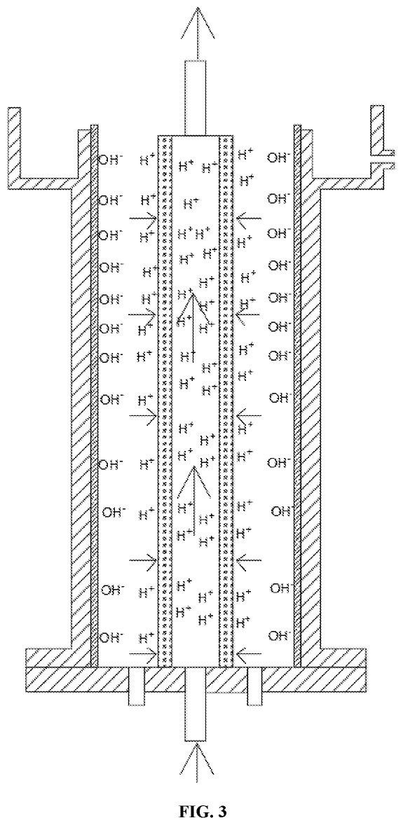

Specifically, as shown in FIG. 2 and FIG. 3, the electrochemical electrolysis unit 2 comprises an electrolysis unit outer shell 2-1, a cathode 2-2 disposed in the inner wall of the outer shell 2-1 and a filter element anode 2-3 disposed in the electrolysis unit outer shell 2-1.

The cathode 2-2 is a porous net cylinder made of stainless steel or titanium; and the filter element anode 2-3 is sleeved with the porous net cylinder cathode 2-2, and a distance between the porous net cylinder cathode 2-2 and the filter element anode 2-3 of the electrochemical electrolysis unit 2 is 1-10 cm.

The filter element anode 2-3 used in the implementation is cylindrical, and has a cavity in side and a porous structure on the wall, filtration precision is 0.45-50 micrometers, and porosity is 35-45%; and a filter element water outlet 2-8 is formed in the top of the filter element anode 2-3.

The filter element anode 2-3 of the implementation is a titanium filter element, a titanium suboxide filter element or a carbon filter element.

When the water body is electrolyzed, acid-alkali mixing is generated between the anode (filter element anode 2-3) and the cathode (cathode 2-2), and in order to solve the problem, the following technical means is adopted: the electrochemical electrolysis unit 2 continuously extracts the acidic water body (such as extracting the acidic water body by using a pump, wherein a second pump 7-2 is used in FIG. 1) near the filter element anode 2-3 from the top end (specifically the filter element water outlet 2-8) of the filter element anode 2-3 in the electrolysis process. Specifically, as shown in FIG. 3, in the extraction process, H⁺ generated by electrolysis outside the filter element anode 2-3 may penetrate through the wall of the filter element anode 2-3 from the exterior of the filter element anode 2-3 into the filter element anode 2-3 and then is extracted from the top end, acid-alkali mixing may be effectively avoided in the process, and therefore the electrolysis efficiency is improved.

While the acidic water body is continuously extracted, the acidic water body extracted from the top end of the filter element anode 2-3 is continuously input into the cavity of the filter element anode 2-3 from the bottom end of the filter element anode 2-3; and the flow of the extracted water body is greater than that of the input water body.

Specifically, in order to achieve the purpose, the following solution may be adopted:

As shown in FIG. 2, a filter element water inlet 2-5 penetrating through the cavity in the filter element anode 2-3 is formed in the bottom wall of the electrolysis unit outer shell 2-1; and

As shown in FIG. 1, the second pump 7-2 is used for extracting the water body (acidic water body) from the interior of the filter element anode 2-3 through the filter element water outlet 2-8; and a fourth pump 7-4 may be used for conveying the acidic water body into the filter element anode 2-3 through the filter element water inlet 2-5, circulation continues, and in the circulation process, the amount (flow) of the water body extracted from the filter element water outlet 2-8 in unit time is greater than that of the water body input from the filter element water inlet 2-5.

As a specific implementation solution, the electrolysis unit outer shell 2-1 is a cylindrical container with the open top end and the closed bottom end; and the lower end of the filter element anode 2-3 is opened, and the lower end is fixed to the bottom wall of the electrolysis unit outer shell 2-1; and

a first water inlet 2-4 is formed in the bottom wall of the outer shell 2-1, an overflow weir 2-6 is disposed at the open end of the outer shell 2-1, and a first water outlet 2-7 is formed in the overflow weir 2-6; and the first water inlet 2-4 is used for inputting the water body with the hardness needing to be removed into the electrochemical electrolysis unit 2, the specific input manner may use a first pump 7-1 shown in FIG. 1, and the first water outlet 2-7 is used for outputting the electrolyzed water body.

### Embodiment 2

Based on the embodiment 1, the embodiment provides a system for specifically used for reducing the hardness of a water body, and the system of the embodiment further comprises a crystalline microfiltration unit 4 and an ion exchange column 5 besides the electrochemical electrolysis unit 2 in the embodiment 1;

the crystalline microfiltration unit 4 is configured to crystallize and filter the water body electrolyzed by the electrochemical electrolysis unit 2; and

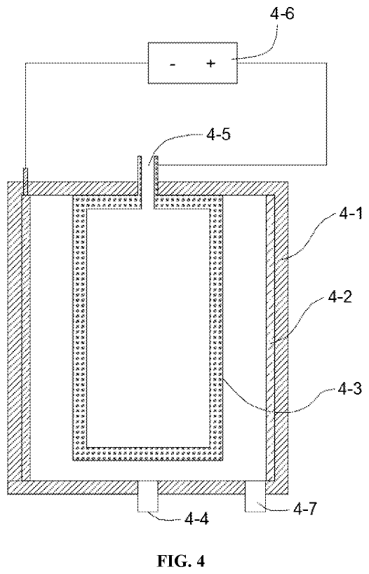

as shown in FIG. 4, the crystalline microfiltration unit 4 comprises a crystalline microfiltration unit outer shell 4-1, a cylindrical cathode 4-2 disposed on the inner wall of the crystalline microfiltration unit outer shell 4-1 and a conductive filter element 4-3 disposed in the crystalline microfiltration unit 4.

As a specific implementation solution, the conductive filter element 4-3 is a titanium filter element, a titanium suboxide filter element or a carbon filter element, and the membrane pore size is 0.1-50 micrometers.

The cylindrical cathode 4-2 is a porous net cylinder made of stainless steel or titanium.

A second water inlet 4-4 communicating with the electrochemical electrolysis unit 2 is formed in the bottom of the crystalline microfiltration unit outer shell 4-1 (‘communicating’ means that the water body can circulate, and ‘communicating’ in this sentence means that the water body can enter the second water inlet 4-4 from the first water outlet 2-7 of the electrochemical electrolysis unit 2);

the conductive filter element 4-3 is a cylindrical filter element, and is fixed to the top wall of the crystalline microfiltration unit outer shell 4-1, a second water outlet 4-5 is formed in the top of the conductive filter element 4-3, and the second water outlet 4-5 penetrates through the top wall of the crystalline microfiltration unit outer shell 4-1 to communicate with the ion exchange column 5; and

a sewage outlet 4-7 is further formed in the bottom of the crystalline microfiltration unit outer shell 4-1 and used for removing crystallized calcium carbonate.

As shown in FIG. 1, the water body flowing out of the first water outlet 2-7 of the electrochemical electrolysis unit 2 enters the position between the cylindrical cathode 4-2 and the conductive filter element 4-3 through the second water inlet 4-4 to be crystallized, the calcium carbonate is precipitated out, and in order to improve the crystallization effect, calcium carbonate seed crystals are put between the cylindrical cathode 4-2 and the conductive filter element 4-3 in advance; and the concentration of the calcium carbonate seed crystals in the crystalline microfiltration unit 4 is greater than 0 g/L and equal to or less than 20 g/L. Out-of-phase crystallization and formation of filter cakes on the conductive filter element 4-3 can be promoted by adding the calcium carbonate seed crystals; the hydraulic retention time is 1-30 min; then the water body is filtered through the conductive filter element 4-3; and the filtered water body is fed into the ion exchange column 4 through a third pump 7-3 for ion exchange.

The water body enters the crystalline microfiltration unit 4 after flowing out of the electrochemical electrolysis unit 2, the water body fully makes contact with the seed crystals through a calcium carbonate seed crystal solution disposed in the crystalline microfiltration unit 4, and thus rapid crystallizing nucleation is achieved; and after the calcium-containing hard water body stays between the cylindrical cathode 4-2 and the conductive filter element 4-3 for several minutes (1-30 min), the effluent is filtered through the conductive filter element 4-3, filter cakes are formed on the surface of the conductive filter element 4-3, the mass transfer effect is improved due to the existence of micro-pore-canals in the filter element and the filter cakes, Ca²⁺ and CO3²⁻ in the water body are fully mixed, the filtering effect is further enhanced, and the removing efficiency of Ca²⁺ is improved.

Along with continuous thickening of the filter cakes formed on the surface of the conductive filter element 4-3, the membrane flux of the conductive filter element 4-3 may be reduced, in order to solve the problem, the crystalline microfiltration unit 4 is provided with a second power source 4-6, a positive electrode of the power source is connected with the conductive filter element 4-3, and a negative electrode of the power source is connected with the cylindrical cathode 4-2. When the membrane flux of the conductive filter element 4-3 is reduced, the power source is switched on for regeneration, and a large amount of carbon dioxide generated after the reaction of H⁺ generated by electrolysis and scale on the surface of the filter element and oxygen generated by electrolysis of the surface of the filter element enable the scale to be more easily peeled and stripped from the surface of the filter element; and the initial flux can be restored within a short time without adding any agent. Current density used for regeneration is 5-30 mA/cm², regeneration time is 1-10 min, and regeneration frequency is 1-5 h once.

The ion exchange column 5 is configured to perform ion exchange on the water body from the crystalline microfiltration unit 4.

The water body from the crystalline microfiltration unit 4 is subjected to ion exchange in the ion exchange column 5, and retention time is 1-5 min.

As a specific implementation solution, the ion exchange column 5 is filled with strong acidic or weak acidic ion exchange resin; and the ion exchange resin specifically may be D113 type resin, DOWEX MAC-3 resin, AMBERLITE IRC83 resin or AMBERLITE IRC84 resin.

The cation exchange resin with which the ion exchange column 5 is filled can further remove Ca²⁺ in the water body from the crystalline microfiltration unit 4, and meanwhile the content of Mg²⁺ hardly removed in the crystalline microfiltration unit 4 is reduced.

Based on the abovementioned system, as an optimized system, an acid storage tank 3 is disposed in the abovementioned system, and the acid storage tank 3 receives the water body (acidic water body) extracted from the interior of the filter element anode 2-3 through the second pump 7-2.

As for the water body stored in the acid storage tank 3, the fourth pump 7-4 can be used for conveying the acidic water body in the acid storage tank 3 into the filter element anode 2-3 through the filter element water inlet 2-5, circulation continues, in the circulation process, the amount (flow) of the water body extracted from the filter element water outlet 2-8 in unit time is greater than that of the water body input from the filter element water inlet 2-5, and more and more acidic water body can be stored in the acid storage tank 3 due to the arrangement.

The flow of the extracted water body is greater than that of the input water body, so that the total amount of acid liquid accumulated in the acid storage tank 3 is increased continuously. Meanwhile, in the extraction and input circulation process, the hardness in the acidic water body may continuously migrate to a cathode area under an electric field so that the content of hardness ions (Ca²⁺ and Mg²⁺) in the acidic water body can be reduced.

Along with use of the ion exchange column 5, the ion exchange resin in the ion exchange column 5 is continuously consumed, and the content of Ca²⁺ and Mg²⁺ in the effluent of the ion exchange column 5 is continuously increased; and at the moment, the crystalline microfiltration unit 4 stops supplying water to the ion exchange column 5, and the fifth pump 7-5 is used for introducing the acid liquid in the acid storage tank 3 into the ion exchange column for regeneration, so as to regenerate the cation exchange resin and restore the adsorption capacity of the ion exchange resin for the Ca²⁺ and Mg²⁺ ions. Hydraulic retention time during regeneration is 1-2 min.

### Embodiment 3

Based on the embodiment 1, the invention provides a method for reducing the hardness of a water body, comprising: (1) the water body is electrolyzed through the electrochemical electrolysis unit 2, wherein the acidic water body near the anode of the electrochemical electrolysis unit 2 is continuously extracted in the electrolysis process.

The first power source 6 supplies power to the electrolysis process, and current density for electrolysis is 1-50 mA/cm².

Specifically, the water body enters the electrochemical electrolysis unit 2 (the water body may be input into the electrochemical electrolysis unit 2 from a feed liquid pool 1 through the first pump 7-1), the first power source 6 is switched on for electrolysis, and the acidic water body generated near the anode of the electrochemical electrolysis unit 2 is continuously extracted (may use the second pump 7-2) in the electrolysis process. Hydraulic retention time during electrolysis is 2-10 min.

By means of the abovementioned method, problems caused by acid-alkali mixing in the electrolysis process can be effectively solved, and in order to better achieve the purpose of reducing the hardness of the water body, the method further comprises following steps:

(2) the electrolyzed water body enters the crystalline microfiltration unit 4 to be crystallized and filtered; and hydraulic retention time is 1-30 min; and

the water body is crystallized between the cylindrical cathode 4-2 and the conductive filter element 4-3 of the crystalline microfiltration unit 4, and the crystallized water body is filtered through the conductive filter element 4-3; in order to improve the crystallization effect, calcium carbonate seed crystals are put between the cylindrical cathode 4-2 and the conductive filter element 4-3 in advance; the concentration of the calcium carbonate seed crystals in the crystalline microfiltration unit 4 is 0-20 g/L; hydraulic retention time is 1-30 min; and when the membrane flux of the conductive filter element 4-3 is reduced, the second power source 4-6 is switched on for regeneration, current density used for regeneration is 5-30 mA/cm², regeneration time is 1-10 min, and regeneration frequency is 1-5 h once.

(3) The filtered water body enters the ion exchange column 5 for ion exchange. Hydraulic retention time is 1-5 min.

As an optimized solution, as shown in FIG. 1, in step 1, the acidic water body near the filter element anode 2-3 is extracted from the top end of the filter element anode 2-3 through the second pump 7-2, the extracted water body is fed into the acid storage tank 3, and then the acidic water body in the acid storage tank 3 is conveyed back into the cavity of the filter element anode 2-3 from the bottom end of the filter element anode 2-3 through the fourth pump 7-4; and the extraction flow is greater than the injection flow.

As an optimized solution, as shown in FIG. 1, in step (3), after the cation exchange resin in the ion exchange column 5 is continuously consumed, the crystalline microfiltration unit 4 can stop supplying water to the ion exchange column 5, and the acidic water body in the acid storage tank 3 is conveyed into the ion exchange column 5 through the fifth pump 7-5 for cleaning and regenerating the cation exchange resin.

Application example:

The hardness of the water body is reduced through the method in the embodiment 3. Specifically,

current density of current entering the electrochemical electrolysis unit 2 is 10 mA/cm², and hydraulic retention time in the electrochemical electrolysis unit 2 is 2 min;

The used filter element anode is a titanium filter element with the porosity of 34-45% and the filtration precision of 10 micrometers.

The extraction flow of the acidic water body is 60 ml/min, and the input flow is 10 ml/min. The pH value of the acidic water body in the acid storage tank 3 reaches 1.5 at the beginning, and is not greatly changed along with the electrolysis process.

5 g/L of calcium carbonate seed crystals (calcium carbonate AR (analytically pure) with the batch number of 20200720 produced by the Sinopharm Chemical Reagent Group is used in the application example) are added into the crystalline microfiltration unit, and hydraulic retention time is 2 min; and

the ion exchange column 5 is filled with D113 type resin, and retention time of the water body in the ion exchange column 5 is 10 s.

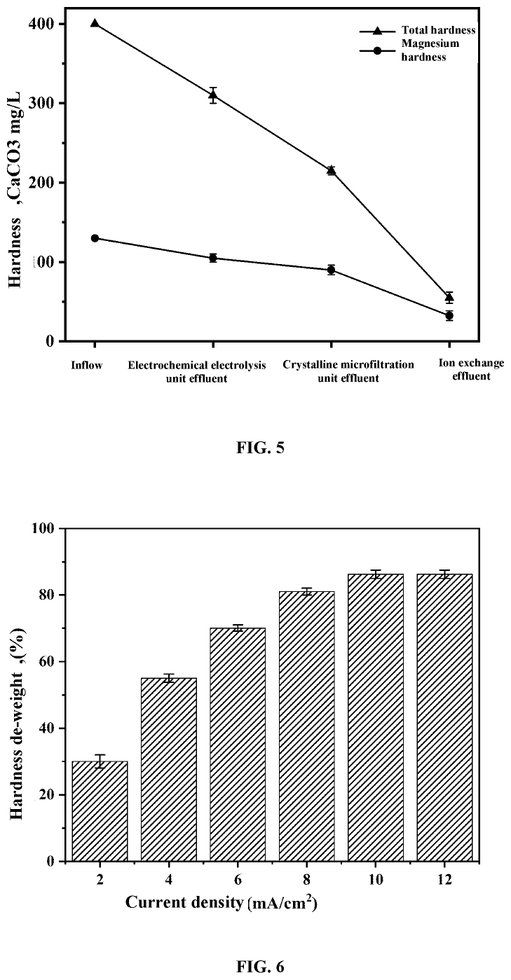

The hardness of the water body at all the stages is shown in FIG. 5. The hardness is gradually reduced after the high-hardness water body flows through the electrochemical electrolysis unit 2 and the crystalline microfiltration unit 4, and finally the ion exchange column 5 further removes hardness ions in the water body, and especially can remove magnesium hardness hardly removed in the front end electrochemical electrolysis unit 2 and crystalline microfiltration unit 4.

The effects for reducing the hardness of the water body under different current densities are tested through the abovementioned method, and the result is shown in FIG. 6. The effect of the system for reducing the hardness of the water body is gradually improved along with continuous increase of the current density, and when the current density reaches 10 mA/cm², the optimal current density condition of the system under the experimental condition is achieved.

After the resin in the ion exchange column 5 is continuously consumed, when the total hardness of effluent of the ion exchange column 5 reaches 100 mg/L (counted by CaCO₃), the acidic water body (pH value being 1.5) in the acid storage tank 3 is used for regenerating the ion exchange column 5, and hydraulic retention time is 1 min during regeneration.

The regeneration rate of the ion exchange column is 80% after the ion exchange column is regenerated for 30 min.

It will be apparent to those skilled in the art that various modifications and variations can be made in the invention without departing from the spirit or scope of the invention. Thus, it is intended that the invention covers the modifications and variations of the invention if they come within the scope of the appended claims and their equivalents.

1. A system for reducing the hardness of a water body, comprising:
an electrochemical electrolysis unit (2) for electrolyzing the water body;
a crystalline microfiltration unit (4) for crystallizing and filtering CaCO₃ in the water body electrolyzed by the electrochemical electrolysis unit (2);
an ion exchange column (5) for performing ion exchange on the water body from the crystalline microfiltration unit (4) to remove Ca²⁺ and Mg²⁺;
and
a first power source (6) for supplying power to the electrochemical electrolysis unit (2);
wherein the electrochemical electrolysis unit (2) comprises a cathode (2-2) and a filter element anode (2-3), the filter element anode (2-3) is cylindrical and has a cavity inside and a porous structure on the wall; and the acidic water body near the filter element anode (2-3) is continuously extracted from the top end of the filter element anode (2-3) in the electrolysis process of the electrochemical electrolysis unit (2), and
wherein the electrochemical electrolysis unit (2) continuously injects the acidic water body extracted from the top end of the filter element anode (2-3) into a cavity of the filter element anode (2-3) from the bottom end of the filter element anode (2-3) in the electrolysis process, and the flow of the extracted acidic water body is greater than that of the injected acidic water body.

2. (canceled)

3. The system for reducing the hardness of the water body according to claim 1, further comprising: an acid storage tank (3) configured to store the acidic water body extracted from the filter element anode (2-3).

4. The system for reducing the hardness of the water body according to claim 3, wherein the acidic water body stored in the acid storage tank (3) is further used for cleaning an ion exchange column (5).

5. The system for reducing the hardness of the water body according to claim 1, wherein the filter element anode (2-3) is a titanium filter element, a titanium suboxide filter element or a carbon filter element; and the cathode (2-2) is a porous net cylinder made of stainless steel or titanium; and a distance between the cathode (2-2) and the filter element anode (2-3) is 1-10 cm.

6. (canceled)

7. The system for reducing the hardness of the water body according to claim 1, wherein the crystalline microfiltration unit (4) comprises a crystalline microfiltration unit outer shell (4-1), a cylindrical cathode (4-2) disposed on the inner wall of the crystalline microfiltration unit outer shell (4-1) and a conductive filter element (4-3) disposed in the crystalline microfiltration unit (4); and the cylindrical cathode (4-2) is a porous net cylinder made of stainless steel or titanium; and the conductive filter element (4-3) is a titanium filter element, a titanium suboxide filter element or a carbon filter element, and a membrane pore size is 0.1-50 micrometers.

8. (canceled)

9. The system for reducing the hardness of the water body according to claim 7, wherein the crystalline microfiltration unit (4) further comprises a second power source (4-6) configured to regenerate the crystalline microfiltration unit (4), a positive electrode of the second power source (4-6) is connected with a conductive filter element (4-3), and a negative electrode of the second power source is connected with a cylindrical cathode (4-2).

10. The system for reducing the hardness of the water body according to claim 1, wherein an ion exchange column (5) is filled with strong acidic or weak acidic cation exchange resin.

11. The system for reducing the hardness of the water body according to claim 10, wherein the cation exchange resin is D113 type resin, DOWEX MAC-3 resin, AMBERLITE IRC83 resin or AMBERLITE IRC84 resin.

12. A method for reducing the hardness of a water body, the method using the system for reducing the hardness of the water body according to claim 9 and comprising:
(1) electrolyzing the water body by using an electrochemical electrolysis unit (2), wherein the electrochemical electrolysis unit (2) continuously injects the acidic water body extracted from the top end of a filter element anode (2-3) into a cavity of the filter element anode (2-3) from the top end of the filter element anode (2-3) in the electrolysis process; and the flow of the extracted acidic water body is greater than that of the injected water body;
(2) enabling the electrolyzed water body to enter a crystalline microfiltration unit (4) to be crystallized and filtered; and
(3) enabling the filtered water body to enter an ion exchange column (5) for ion exchange.

13. The method for reducing the hardness of the water body according to claim 12, wherein in step (2), when the membrane flux of a conductive filter element (4-3) is reduced, a second power source (4-6) is switched on for regeneration, current density used for regeneration is 5-30 mA/cm², regeneration time is 1-10 min, and regeneration frequency is 1-5 h once.

14. The method for reducing the hardness of the water body according to claim 12, wherein in step (3), when the hardness of the water body flowing out of the ion exchange column (5) reaches 100 mg/L, the acidic water, extracted from the top end of the filter element anode (2-3), in the cavity of the filter element anode (2-3) is used for cleaning and regenerating.

15. (canceled)
